(19) United States
(12) Patent Application Publication
(10) Pub. No.: US 2023/0196700 A1
(43) Pub. Date: Jun. 22, 2023

(54) IMAGE PROCESSING APPARATUS AND IMAGE PROCESSING METHOD

(71) Applicant: SONY GROUP CORPORATION, TOKYO (JP)

(72) Inventor: TAKUMI TSURU, TOKYO (JP)

(21) Appl. No.: 17/925,571

(22) PCT Filed: May 12, 2021
(86) PCT No.: PCT/JP2021/017986

§ 371 Date: Nov. 15, 2022

(30) Foreign Application Priority Data
May 26, 2020 (JP) 2020-091282

(51) Int. Cl. G06T 19/20; G06T 15/20; G06T 7/62

(52) U.S. Cl. CPC G06T 19/20; G06T 15/20; G06T 7/62; G06T 2207/10028; G06T 2219/2016; G06T 2210/36; G06T 2210/56

(57) ABSTRACT

The present disclosure relates to an image processing apparatus and an image processing method capable of suppressing degradation of subjective image quality while suppressing an increase in load.

On the basis of the display size of a point cloud object depending on the relative position of the point cloud object based on the position of a viewpoint, the necessary point density that is the density of points necessary for displaying the point cloud object is calculated, and the content file of LoD in which the density of points of the point cloud object is equal to or higher than the calculated necessary point density is selected. The present disclosure can be applied to, for example, an image processing apparatus, an information processing apparatus, a reproduction device, a 3D rendering device, an electronic device, a method thereof, and the like.

### TECHNICAL FIELD

The present disclosure relates to an image processing apparatus and an image processing method, and more particularly, to an image processing apparatus and an image processing method capable of suppressing degradation of subjective image quality while suppressing an increase in load.

### BACKGROUND ART

Conventionally, coding and decoding of point cloud data representing a three-dimensional object as a set of points has been standardized by Moving Picture Experts Group (MPEG) (see, for example, Non-Patent Document 1 and Non-Patent Document 2).

In order to suppress an increase in the amount of information to be transmitted when the 3D data is distributed using such a technique, a method of preparing data of a plurality of levels of detail (LoDs), and selecting and distributing LoD as necessary has been considered. For example, by selecting LoD with appropriate definition depending on the distance from a viewpoint to an object, it is possible to suppress an increase in the amount of information to be transmitted (that is, an increase in load) while suppressing degradation of subjective image quality.

### CITATION LIST

### Non-Patent Document

Non-Patent Document 1: “Information technology—MPEG-I (Coded Representation of Immersive Media)—Part 9: Geometry-based Point Cloud Compression”, ISO/IEC 23090-9:2019 (E)
Non-Patent Document 2: “Information technology—Coded Representation of Immersive Media—Part 5: Video-based Point Cloud Compression”, ISO/IEC 23090-5:2019(E)

### SUMMARY OF THE INVENTION

### Problems to be Solved by the Invention

However, the appropriate definition varies not only by the distance between a viewpoint and an object, but also by the angle of an object position with respect to the orientation of the viewpoint. Therefore, in the method described above, the appropriate LoD cannot be selected, and there is a possibility that the subjective image quality is degraded or the load is increased.

The present disclosure has been made in view of such circumstances, and an object of the present disclosure is to suppress degradation of subjective image quality while suppressing an increase in load in rendering of 3D data.

### Solutions to Problems

An image processing apparatus according to one aspect of the present technology is an image processing apparatus including a necessary density calculation unit that calculates, on the basis of a display size of a point cloud object depending on a relative position of the point cloud object based on a position of a viewpoint, a necessary point density that is a density of points necessary for displaying the point cloud object, and a selection unit that selects a content file of LoD in which a density of points of the point cloud object is equal to or higher than the necessary point density calculated by the necessary density calculation unit.

An image processing method according to one aspect of the present technology is an image processing method including calculating, on the basis of a display size of a point cloud object depending on a relative position of the point cloud object based on a position of a viewpoint, a necessary point density that is a density of points necessary for displaying the point cloud object, and selecting a content file of LoD in which a density of points of the point cloud object is equal to or higher than the necessary point density calculated.

An image processing apparatus according to another aspect of the present technology is an image processing apparatus including a necessary density calculation unit that calculates, on the basis of a display size of a point cloud object depending on a relative position of the point cloud object based on a position of a viewpoint, a necessary point density that is a density of points necessary for displaying the point cloud object, a selection unit that selects a content file of LoD on the basis of a distance from the viewpoint to the point cloud object, and a correction unit that corrects a density of points of the point cloud object in the content file of the LoD selected by the selection unit so as to be equal to or higher than the necessary point density calculated by the necessary density calculation unit.

An image processing method according to another aspect of the present technology is an image processing method including calculating, on the basis of a display size of a point cloud object depending on a relative position of the point cloud object based on a position of a viewpoint, a necessary point density that is a density of points necessary for displaying the point cloud object, selecting a content file of LoD on the basis of a distance from the viewpoint to the point cloud object, and correcting a density of points of the point cloud object in the content file of the LoD selected o as to be equal to or larger than the necessary point density calculated.

In the image processing apparatus and the image processing method according to one aspect of the present technology, on the basis of the display size of the point cloud object depending on the relative position of the point cloud object based on the position of the viewpoint, the necessary point density that is the density of points necessary for displaying the point cloud object is calculated, and the content file of the LoD in which the density of points of the point cloud object is equal to or higher than the necessary point density calculated is selected.

In the image processing apparatus and the image processing method according to another aspect of the present technology, on the basis of the display size of the point cloud object depending on the relative position of the point cloud object based on the position of the viewpoint, the necessary point density that is the density of points necessary for displaying the point cloud object is calculated, the content file of the LoD is selected on the basis of the distance from the viewpoint to the point cloud object, and the density of points of the point cloud object in the content file of the LoD selected is corrected as to be equal to or larger than the necessary point density calculated.

### BRIEF DESCRIPTION OF DRAWINGS

FIG. 1 is a diagram illustrating an example of Scene Description.

FIG. 2 is a diagram illustrating an example of a state of switching of LoDs depending on a distance.

FIG. 3 is a diagram illustrating an example of a state of perspective projection.

FIG. 4 is a diagram illustrating an example of a change in a display size due to a difference in a perspective position in a horizontal direction.

FIG. 5 is a diagram illustrating an example of a pixel display interval.

FIG. 6 is a diagram illustrating an example of a change in a display size due to a difference in a perspective position in a vertical direction.

FIG. 7 is a diagram illustrating an example of a circumscribed sphere of an object.

FIG. 8 is a diagram illustrating an example of a state where the stretching magnification is calculated.

FIG. 9 is a diagram illustrating an example of a minimum point interval for each LoD.

FIG. 10 is a diagram illustrating an example of an angle of an object position.

FIG. 11 is a diagram illustrating an example of a stretching magnification for a viewing angle.

FIG. 12 is a diagram illustrating an example of an LoD boundary in the horizontal direction.

FIG. 13 is a block diagram illustrating a main configuration example of a reproduction device.

FIG. 14 is a flowchart for explaining an example of a flow of a reproduction process.

FIG. 15 is a flowchart for explaining an example of a flow of an analysis display process.

FIG. 16 is a diagram for explaining an example of a state of cooperation between LoD selection and an interpolation process.

FIG. 17 is a view illustrating an example of stretching in the horizontal direction.

FIG. 18 is a diagram illustrating an example of a state of point interpolation.

FIG. 19 is a diagram illustrating an example of the state of point interpolation.

FIG. 20 is a block diagram illustrating a main configuration example of a reproduction device.

FIG. 21 is a flowchart for explaining an example of a flow of a reproduction process.

FIG. 22 is a flowchart for explaining an example of a flow of an analysis display process.

FIG. 23 is a block diagram illustrating a main configuration example of a computer.

### MODE FOR CARRYING OUT THE INVENTION

Hereinafter, modes for carrying out the present disclosure (hereinafter, referred to as “embodiments”) will be described. It should be noted that the description is given in the following order.

1. First Embodiment (Reproduction Device)

2. Second Embodiment (Reproduction Device)

3. Appendix

### 1. FIRST EMBODIMENT

<Documents and the Like Supporting Technical Contents and Technical Terms>

The scope disclosed in the present technology includes not only the contents described in the embodiments but also the contents described in the following non-patent documents and the like known at the time of filing, the contents of other documents referred to in the following non-patent documents, and the like.

Non-Patent Document 1 (described above)

Non-Patent Document 2 (described above)

That is, the contents described in the non-patent documents, the contents of other documents referred to in the non-patent documents, and the like are also grounds for determining the support requirement.

<Rendering of Point Cloud>

Conventionally, various video distribution services have been used, and in addition to 2D video distribution of mainstream movies and the like, 360-degree video distribution capable of looking around in all directions has also been performed. This 360-degree video is basically the same as 2D video distribution. Further, a video distribution technology for providing a viewing experience at a free viewpoint position is also being developed. In this case, in order to enable viewing from all positions, everything appearing in a video content is distributed as a 3D object video such as a point cloud or a mesh.

In that case, there is a possibility that the amount of data to be distributed becomes very large. For example, there is a possibility that a problem that high-definition video distribution cannot be performed as it is due to band limitation may occur. In particular, the point cloud object that represents a 3D shape with points can more finely represent the 3D shape than the mesh object that represents the 3D shape with surfaces, but the amount of information required is large.

For example, in the case of a point cloud, a three-dimensional structure (a three-dimensional object) is represented as a set of a large number of points. The point cloud data includes position information (also referred to as “geometry data”) and attribute information (also referred to as “attribute data”) of each point. The attribute data can include any information. For example, color information, reflectance information, normal line information, and the like of each point may be included in the attribute data. As described above, the point cloud data has a relatively simple data structure, and can represent any three-dimensional structure with sufficient definition by using a sufficiently large number of points. Note that, as described above, the amount of information increases as the definition increases.

Therefore, a method has been considered in which pieces of model data of a plurality of levels of detail (LoDs) are prepared for one 3D object, and the LoD is selected and distributed as necessary. For example, by selecting LoD with appropriate definition depending on the distance from a viewpoint to an object, it is possible to suppress an increase in the amount of information to be transmitted (that is, an increase in load) while suppressing degradation of subjective image quality.

The LoD indicates the level of definition of point cloud data. The definition of the point cloud data depends on the number of points. That is, pieces of point cloud data with a plurality of definitions (numbers of points) are prepared for one object as LoDs, and the definition (the number of points) is selected as necessary.

For example, the object close to a viewpoint position requires detailed information because the object is displayed large. Therefore, high-LoD model data having a large number of points is selected. On the other hand, the object away from the viewpoint position does not require detailed information because the object is displayed small. Therefore, low-LoD model data having a small number of points is selected. As a result, it is possible to suppress an unnecessary increase in the amount of information to be transmitted, and to suppress an increase in the load related to distribution. Furthermore, since the increase in the amount of information is suppressed, the increase in the load of a rendering process can also be suppressed. Therefore, it is possible to suppress an increase in cost and to achieve high-speed communication and processing.

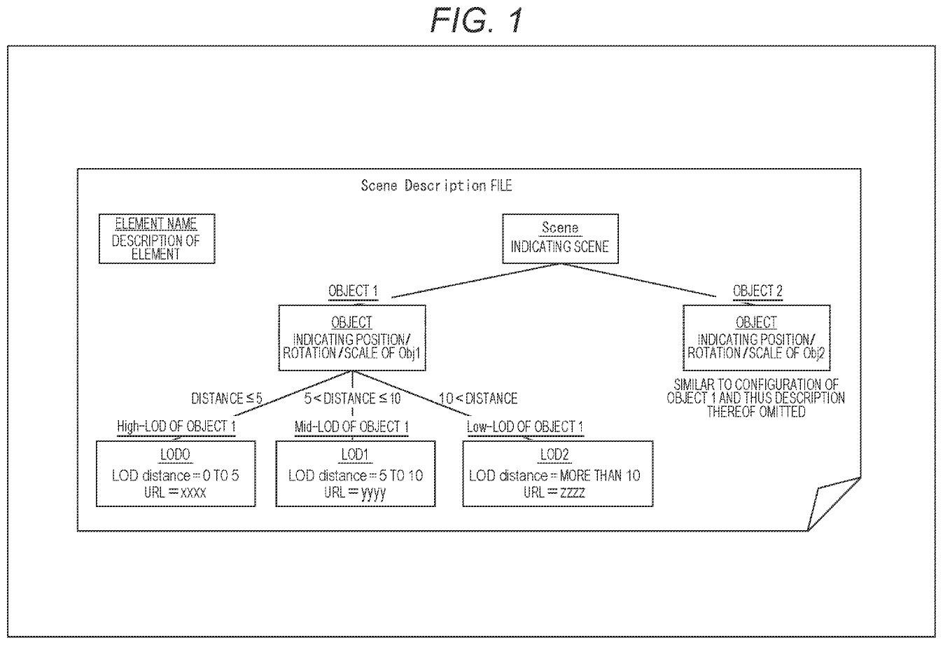

For example, as illustrated in FIG. 1, information related to each LoD of each object is described in a file in which the configuration information of a 3D space called scene description is collected.

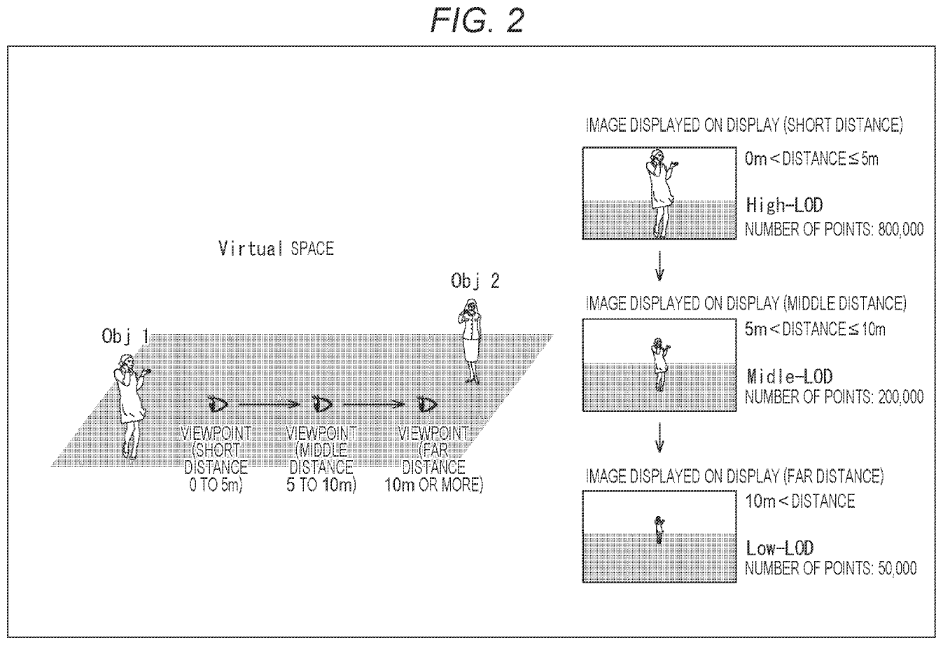

For example, as illustrated in FIG. 2, the client performs video reproduction while switching the model data (LoD) of an object to be acquired depending on “LOD distance” described in the scene description file and the change in the distance between a viewpoint position and each object position due to the user's operation.

For example, in a case where a point cloud object Obj1 is present at a far distance from the viewpoint position (for example, a position more than 10 m away from the viewpoint position), high-definition and high-rate information is not required, and thus, the model data with low-definition and low-rate Low-LoD (the number of points is 50,000) is selected. Furthermore, in a case where the point cloud object Obj1 is present at a middle distance from the viewpoint position (for example, a position 5 m to 10 m away from the viewpoint position), higher-definition and higher-rate information is required as compared with the case of a far distance, and thus, the model data with medium-definition and medium-rate Mid-LoD (the number of points is 200,000) is selected. Moreover, in a case where the point cloud object Obj1 is present at a short distance from the viewpoint position (for example, a position within 5 m from the viewpoint position), higher-definition and higher-rate information is required as compared with the case of a middle distance, and thus, the model data with high-definition and high-rate High-LoD (the number of points is 800,000) is selected.

As described above, by performing distribution while switching the LoD depending on the distance from the viewpoint position to the object, it is possible to suppress an increase in the amount of information to be transmitted while suppressing the degradation of the subjective image quality.

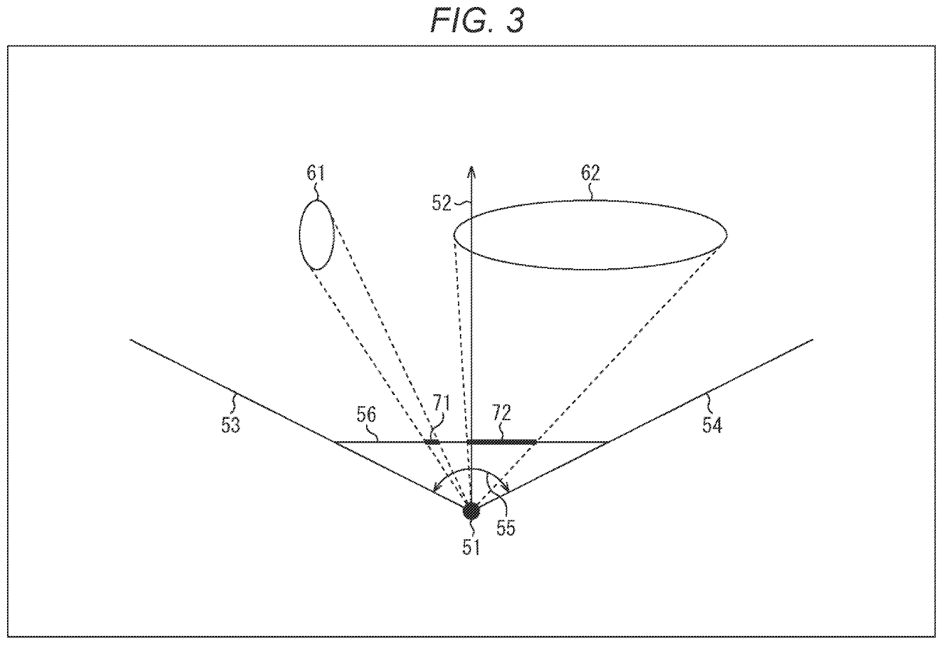

Furthermore, in order to display the video of the 3D space viewed from the viewpoint position on a display, a rendering method called perspective projection for drawing a three-dimensional object on a two-dimensional plane is used as illustrated in FIG. 3.

Then, for a field of view (FOV) at the time of projection, by performing projection at a wider angle like a human eye, it is possible to obtain an effect of enhancing power and realistic feeling. Therefore, such a wide field of view is required in various 3D applications including free viewpoint video distribution (object distribution).

The example of FIG. 3 illustrates a state of perspective projection in a horizontal direction in a case of viewing in a viewpoint orientation 52 from a viewpoint position 51. In this case, the range of a double-headed arrow 55 between a straight line 53 and a straight line 54 is the field of view (FOV). That is, the angle of this range is the field of view. In this case, a projection plane 56 perpendicular to viewpoint orientation 52 is set, and the image projected on projection plane 56 is a display image.

For example, when viewed from the viewpoint position 51, an object 61 appears to be projected on a range 71 indicated by a thick line on the projection plane 56. Furthermore, an object 62 appears to be projected on a range 72 indicated by a thick line on the projection plane 56. That is, in the display image, the image of the object 61 is displayed in a portion corresponding to the range 71, whereas the image of the object 62 is displayed in a portion corresponding to the range 72.

Meanwhile, when the 3D space is perspectively projected at a wide angle, an object projected at a position away from the center of the projection plane is displayed in a distorted manner as if being greatly stretched. This is because any existing projection method cannot avoid distortion at the time of projection onto a plane, and the distortion becomes remarkable when the angle is made wide, which is a phenomenon similar to distortion of a photograph taken with a wide-angle lens. Therefore, even if the distance from the viewpoint position to the object is the same, the display size varies depending on the projection position, and the required definition (LoD) varies accordingly.

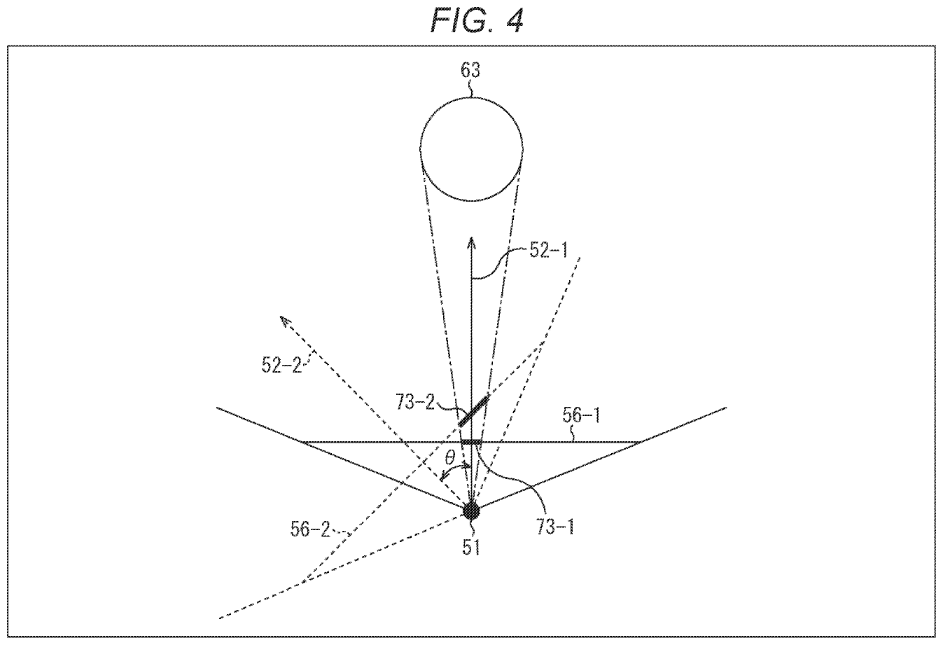

For example, in the case of FIG. 4, when viewed from the viewpoint position 51 in a viewpoint orientation 52-1, an object 63 is projected on a range 73-1 of a projection plane 56-1 in that case. On the other hand, when viewed from the viewpoint position 51 in a viewpoint orientation 52-2 with an angle θ to the viewpoint orientation 52-1, the object 63 is projected on a range 73-2 of a projection plane 56-2 in that case. The distance between the viewpoint position 51 and the object 63 is the same in both cases, but the range 73-2 is clearly wider than the range 73-1. That is, the object 63 is displayed larger in the case of the viewpoint orientation 52-2 than in the case of the viewpoint orientation 52-1. Therefore, in a case where the same LoD is selected for the object 63 in the case of the viewpoint orientation 52-1 and the case of the viewpoint orientation 52-2, the subjective image quality of the object 63 may be degraded in the case of the viewpoint orientation 52-2 as compared with the case of the viewpoint orientation 52-1.

Since the point cloud represents an object by a set of points, in a case where the definition of a point cloud object is insufficient for a display pixel (a pixel pitch in a display image), pixels that do not display points in the display image are generated, and thus image quality degradation such as a hole is generated. That is, in order to suppress such degradation of the subjective image quality, the point cloud object needs to have definition equal to or higher than the pixel pitch of the display image.

If the LoD switching distance is set according to the end of the projection plane 56 on which the object is displayed in the largest size, the definition becomes unnecessarily high at the center of the projection plane 56 on which the object is displayed in the smallest size, and the amount of information may increase. Conversely, if the LoD switching distance is set according to the center of the projection plane 56 on which the object is displayed in the smallest size, as described above, the definition becomes insufficient at the end of the projection plane 56 on which the object is displayed in the largest size, and the subjective image quality may be degraded.

That is, in the method of switching the LoD depending on a distance, it is not possible to implement appropriate switching of the LoD in the point cloud object distribution.

Note that, although many correction techniques for the distortion at the time of wide-angle projection have been developed, these correction techniques are techniques for correcting a distorted 2D video, and even if the distortion is corrected by this correction technique, it is difficult to suppress the degradation of the subjective image quality of the point cloud object described above.

In addition, a method of upsampling points so as to prevent insufficient definition is considered. However, in the determination based only on a distance, it is difficult to determine how much the definition is insufficient depending on the projection position of the object and to execute control as to how to perform upsampling as described above.

<LoD Selection Based on Projection Position>

Therefore, on the basis of the display size of a point cloud object depending on the relative position of the point cloud object based on the position of a viewpoint, the necessary point density that is the density of points necessary for displaying the point cloud object is calculated, and the content file of LoD in which the density of points of the point cloud object is equal to or higher than the calculated necessary point density is selected.

For example, the image processing apparatus includes a necessary density calculation unit that calculates, on the basis of the display size of a point cloud object depending on the relative position of the point cloud object based on the position of a viewpoint, a necessary point density that is the density of points necessary for displaying the point cloud object and a selection unit that selects the content file of LoD in which the density of points of the point cloud object is equal to or higher than the necessary point density calculated by the necessary density calculation unit.

That is, since the projection position and the size of the object are determined from the distance between the viewpoint position and the object position and the viewing angle, the point density (the point interval) necessary and sufficient for the display pixel in a case where the object is projected at the position with the size is calculated. Then, the LoD model with a density equal to or higher than the necessary and sufficient point density is selected. When the point density is replaced with the point interval, the LoD model with an interval equal to or less than the calculated point interval is selected. Note that the point interval here means the minimum point interval (the distance between two closest points in terms of the structure of a point cloud) of the LoD model data.

As a result, the LoD can be selected depending on the display size of the point cloud object so that the subjective image quality is not degraded. Therefore, it is possible to suppress the degradation of the subjective image quality while suppressing an increase in load.

<Calculation of Necessary Point Density>

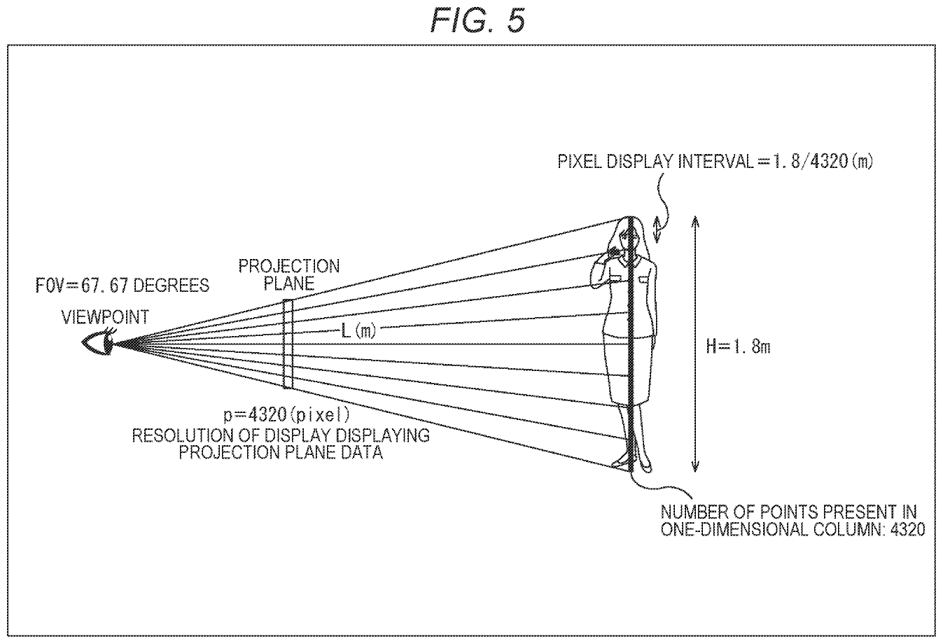

The position on which an object is projected can be specified from the distance between a viewpoint position and the object and a viewing angle, and “display interval of pixels” displayed at that time can be calculated. “Pixel display interval” is obtained by dividing the length of a display object by the number of display pixels. FIG. 5 illustrates an example thereof.

In the example of FIG. 5, a human object with a height of 1.8 m is displayed with 4320 pixels when considered in a one-dimensional column in a height direction. In this case, “pixel display interval” is 1.8/4320 (m). If the point interval of this model data is the same, that is, 1.8/4320 (m), it can be said that this is the model data with the point density necessary for suppressing the degradation of the subjective image quality, for the display pixel. In the case of model data in which the point interval is larger (the point density is lower), the definition of the point cloud is insufficient for the number of display pixels, and image quality degradation such as a hole is generated. That is, this “pixel display interval” corresponds to the point interval necessary for suppressing the degradation of the subjective image quality.

For “pixel display interval” calculated in consideration of viewing angle information in addition to the distance from the viewpoint position to the object, if the LoD model data that satisfies the following inequality (1) and has a point interval closest to “pixel display interval” (that is, the LoD model data with the widest point interval (the smallest point density)) is selected, it is possible to efficiently select the LOD without insufficient definition due to wide-angle distortion or without unnecessarily acquiring the definition and the amount of information. That is, it is possible to suppress the degradation of the subjective image quality while suppressing an increase in load.

“point interval (m)” of model data≤“pixel display interval (m)” in case where object is displayed (1)

“Pixel display interval (m)” obtained in consideration of such a viewing angle is calculated as follows.

<Step 1>

“Pixel display interval (m)” in a case where the object is viewed from the front is calculated from the following equation (2). This means “pixel display interval (m)” when the object is projected at the center of a projection plane, that is, when distortion caused by the object being stretched and displayed is not generated.

$$pi\_center = 2 * L * tan ( \frac{FOV}{2} ) / p \qquad ( 2 )$$

Note that, in equation (2), pi_center indicates “pixel display interval (m)” when viewed from the front,

L indicates a distance (m) from the viewpoint position to the object,

FOV indicates a vertical FOV or a horizontal FOV, and

P indicates the number of one-dimensional pixels (a height or width) in the horizontal direction or the vertical direction.

<Step 2>

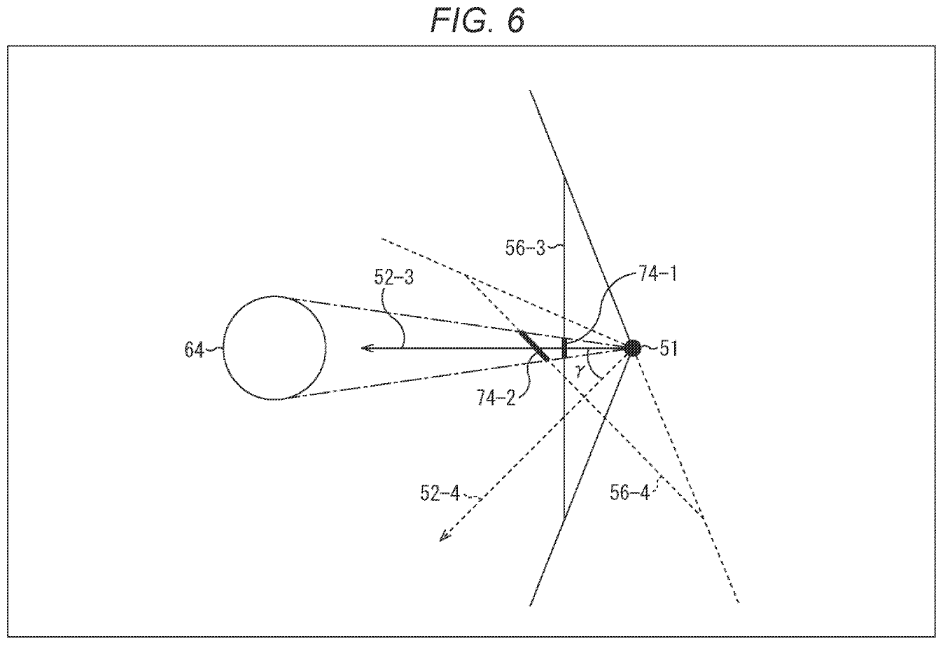

Th viewing angle of the object is measured, and a ratio (a magnification) of the number of pixels to be used when viewed from the angle to the number of pixels to be used when viewed from the front is calculated. This corresponds to the ratio of “display size when viewed from angle θ (that is, the display size in the case of the viewpoint orientation 52-2)” to “display size when viewed from front (that is, the display size in the case of the viewpoint orientation 52-1)” in FIG. 4. Note that the example of FIG. 4 is an example in the horizontal direction. An example in the vertical direction is illustrated in FIG. 6.

In the case of FIG. 6, when viewed from the viewpoint position 51 in a viewpoint orientation 52-3, an object 64 is projected on a range 74-1 of a projection plane 56-3 in that case. On the other hand, when viewed from the viewpoint position 51 in a viewpoint orientation 52-4 with an angle γ to the viewpoint orientation 52-3, the object 64 is projected on a range 74-2 of a projection plane 56-4 in that case.

That is, also in the vertical direction, the ratio of “display size when viewed from angle γ” to “display size when viewed from front” can be calculated as in the case of the horizontal direction. In other words, this ratio (magnification) is calculated in each of the horizontal direction and the vertical direction. Then, as in the following equation (3), the larger one of these magnifications is calculated as the final magnification.

M=max(Mh,Mv) (3)

Note that, in equation (3),

M indicates a stretching magnification (a larger one) at a viewing angle,

Mh indicates a stretching magnification in the horizontal direction, and

My indicates a stretching magnification in the vertical direction.

In order to calculate Mh or Mv, size information of the object is required. For example, a client obtains circumscribed sphere information of the object from a server. Alternatively, the circumscribed sphere information may be calculated by the client itself.

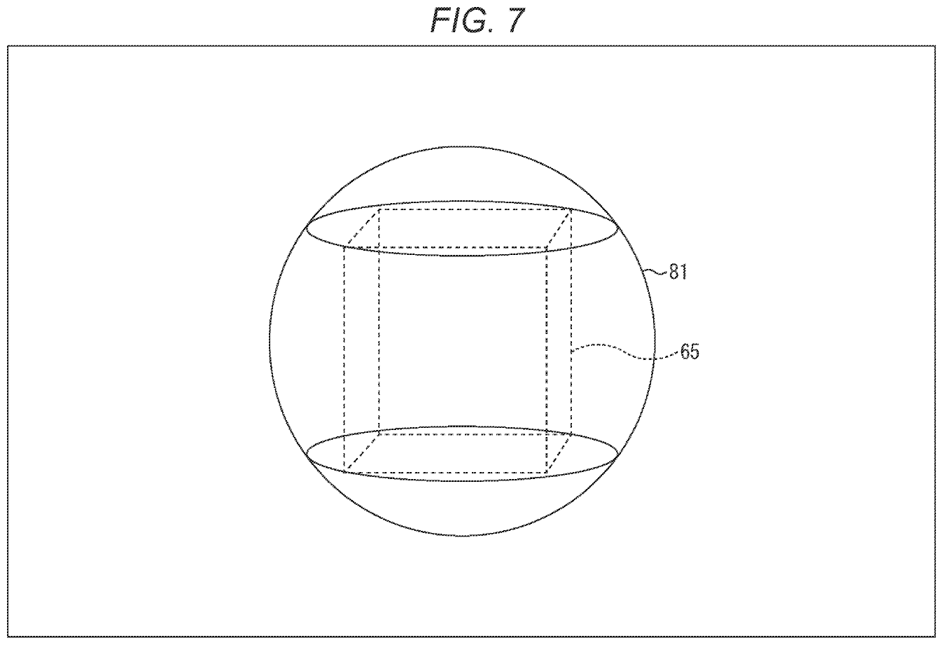

The circumscribed sphere of a 3D object is a sphere having a size necessary to surround the 3D object as illustrated in FIG. 7 for example, and the circumscribed sphere information includes center position information (x, y, z) of the sphere and length information of the radius of the sphere. That is, the circumscribed sphere information is information related to the size and position of the 3D object. A circumscribed sphere 81 illustrated in FIG. 7 is a circumscribed sphere of a 3D object 65. Note that the circumscribed sphere 81 is only required to include the 3D object 65, and does not need to circumscribe the 3D object. That is, the size does not need to be the minimum size.

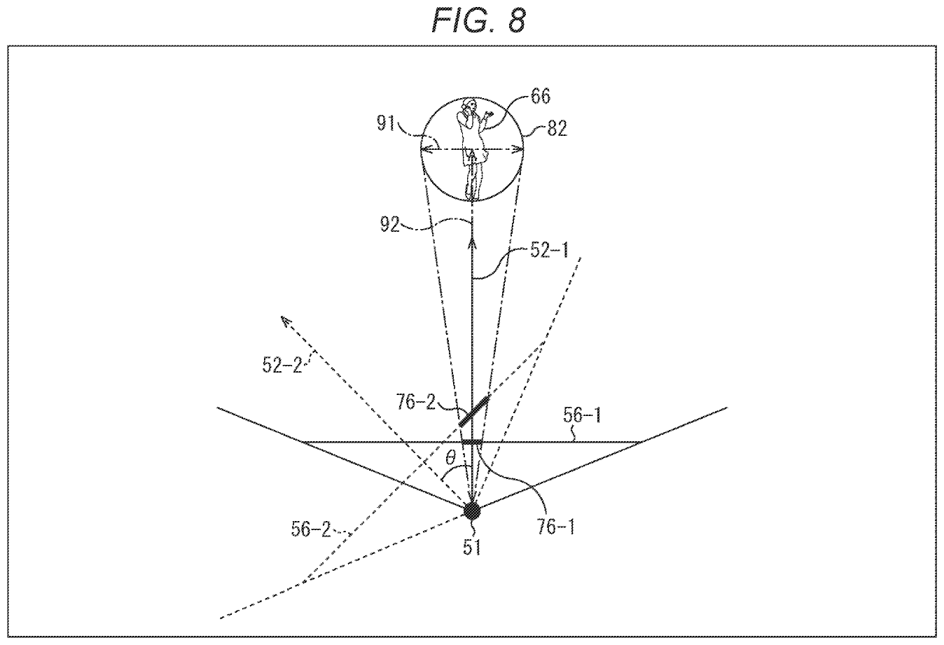

The situation illustrated in FIG. 8 will be described. In the case of FIG. 8, when viewed from the viewpoint position 51 in the viewpoint orientation 52-1, an object 66 on the viewpoint orientation 52-1 is projected on a range 76-1 of the projection plane 56-1 in that case. On the other hand, when viewed from the viewpoint position 51 in the viewpoint orientation 52-2 with the angle θ to the viewpoint orientation 52-1, the object 66 is projected on a range 76-2 of the projection plane 56-2 in that case.

At that time, assuming that the radius of a circumscribed sphere 82 (a sphere with a diameter of a double-headed arrow 91) of the object 66 is denoted by r, and the distance (a double-headed arrow 92) from the viewpoint position 51 to the center of the circumscribed sphere 82 is denoted by L. Furthermore, it is assumed that the center of the circumscribed sphere 82 is located on the viewpoint orientation 52-1. Moreover, the angle (the angle from the center of the field of view to the end of the range 76-1 or 76-2) from the viewpoint orientation 52-1 to the end of the circumscribed sphere 82 when viewed from the viewpoint position 51 is denoted by β.

In this situation, in the case of calculating the stretching magnification in the horizontal direction, that is, (the display size viewed from the angle θ)/(the display size viewed from the front (horizontal)), first, the angle β is calculated from the distance L (m) to the object 66 and the length r (m) of the radius of the circumscribed sphere 82. By using β, the stretching magnification Mh can be calculated as in the following equation (4).

$$Mh = \frac{{cos}^{2} β}{{cos}^{2} β * {cos}^{2} θ - {sin}^{2} β * {sin}^{2} θ} \qquad ( 4 )$$

Similarly, assuming that the viewing angle in the vertical direction is denoted by γ, the stretching magnification My in the vertical direction can be calculated as in the following equation (5).

$$Mv = \frac{{cos}^{2} β}{{cos}^{2} β * {cos}^{2} γ - {sin}^{2} β * {sin}^{2} γ} \qquad ( 5 )$$

The larger one of these two stretching magnifications is adopted as the stretching magnification. This means that even a small magnification can be covered by adjusting the stretching magnification to the larger stretching magnification.

<Step 3>

As in the following equation (6), “pixel display interval (m)” in a case where the object is viewed from a viewing angle is calculated by dividing “pixel display interval (m)” calculated in <Step 1> in a case where the object is viewed from the front by the stretching magnification due to distortion calculated in <Step 2>.

$$pi\_side = \frac{pi\_center}{M} \qquad ( 6 )$$

Note that, in equation (6), pi_side indicates “pixel display interval (m)” when viewed from a certain viewing angle, and

M indicates a stretching magnification at the viewing angle.

With the above three steps, the client calculates “pixel display interval” (pi_side) at the time of display from the distance and angle at which the object is viewed. As described above, this is the point interval required in the point cloud object displayed at the position. By selecting the LoD with the fineness equal to or more than this interval and with the point interval of the closest value, it is possible to select the optimum LoD without excess or deficiency in definition.

### Calculation Example

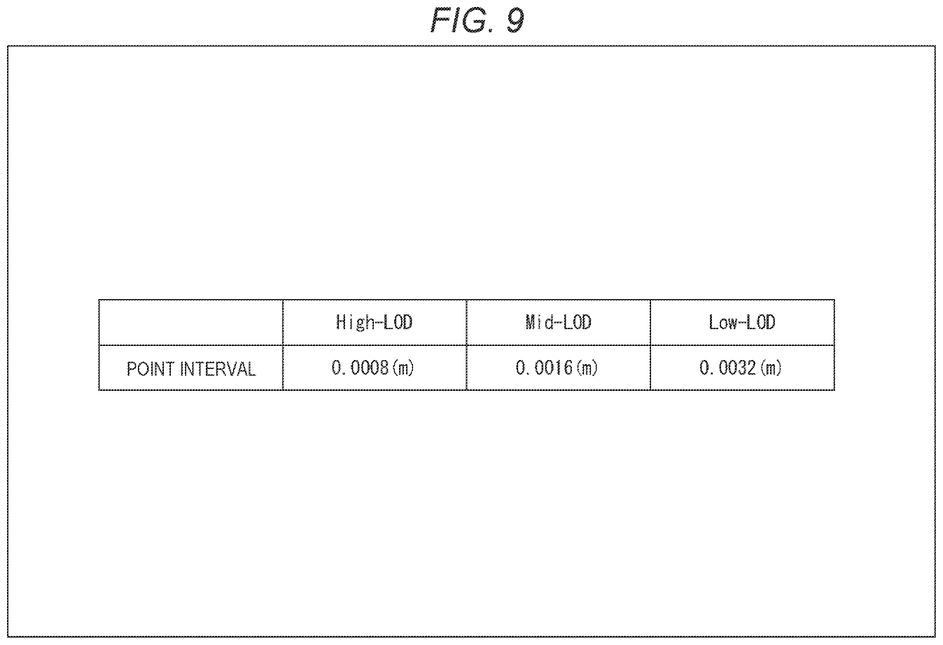

For example, it is assumed that the point cloud object has three LoD models with point intervals as shown in the table of FIG. 9. Furthermore, it is assumed that the resolution (Width) of a display in the horizontal direction, the horizontal FOV, the radius (r) of an object circumscribed sphere, and the distance (L) from a viewpoint position to the center of the object circumscribed sphere have the following values.

Resolution of display in horizontal direction (Width): 7680

Horizontal FOV: 100 degrees

Radius (r) of object circumscribed sphere: 1 m

Distance (L) from viewpoint position to center of object circumscribed sphere: 12 m

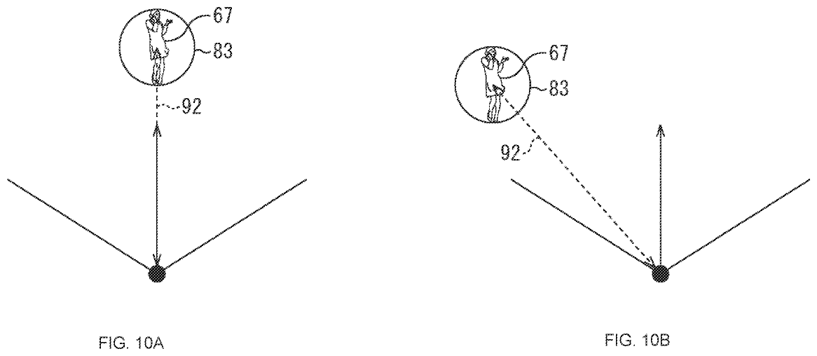

In this case, first, “pixel display interval (m)” at which an object 67 is displayed in a case where the object 67 is viewed from the front at a position separated by 12 m as illustrated in A of FIG. 10, and “pixel display interval (m)” at which the object 67 is displayed in a case where the object 67 is viewed from a viewing angle of 50 degrees in the horizontal direction at a position separated by 12 m as illustrated in B of FIG. 10 are as follows.

Pixel display interval (0 degrees)=0.003724 (m)

Pixel display interval (50 degrees)=0.001524 (m)

Therefore, on the basis of the table of FIG. 9, Low-LOD (point interval=0.0032 m) is selected in a case where the object 67 is viewed from the front.

On the other hand, in a case where the object 67 is viewed from a viewing angle of 50 degrees in the horizontal direction, High-LOD (point interval=0.0008 m) is selected. Although the pixel display interval is closer to 0.0016 for the mid-LOD, the pixel display interval is finer, so that the subjective image quality may be degraded. Therefore, instead of selecting the closest one, the point interval that has a higher density than the calculated “pixel display interval” and the closest thereto is selected. Therefore, the High-LOD is selected in this example.

As described above, even at the same distance, the required definition varies depending on the difference in the angle (the projection position) at which the object is viewed. Low-LOD with the lowest definition is sufficient when viewed from the front, whereas High-LOD with the highest definition is required when viewed at an angle of 50 degrees.

In the LOD with the point interval illustrated in FIG. 9, when the object is viewed from the front, the distance from the viewpoint position at which the point interval of the Mid-LOD is exactly the same as “pixel display interval” is 5 m, and the distance is 10 m for Low-LOD (it can be calculated by back calculating equation (2)). That is, the distance serving as the boundary between the High-LOD and the Mid-LOD in front of the object is 5 m, and the distance serving as the boundary between the Mid-LOD and the Low-LOD is 10 m. The boundary distance at each viewing angle is obtained by multiplying the boundary distance in the front by a magnification calculated by substituting the viewing angle into θ and γ in equations (4) and (5).

<Boundary Map>

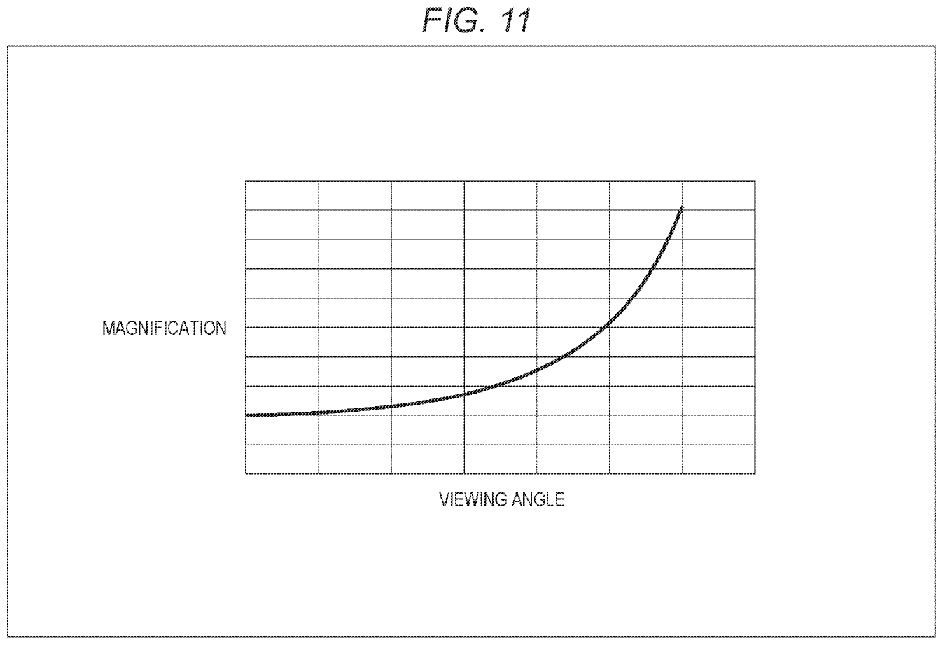

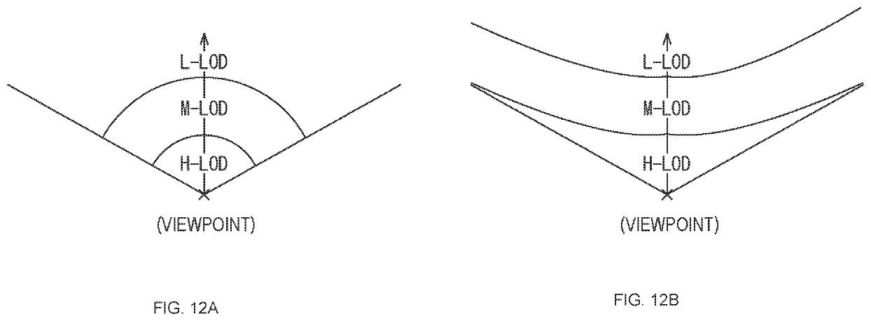

That is, the relationship between the viewing angle and the magnification is illustrated in the graph of FIG. 11. Furthermore, each LoD boundary in a case where the LoD is switched depending on a distance can be represented as map information as in A of FIG. 12. Moreover, each LoD boundary in a case where the LoD is switched depending on the viewing angle can be represented as map information as in B of FIG. 12.

As described above, the LOD may be selected by, instead of calculating the point density (the point interval) necessary for suppressing the degradation of the subjective image quality, using the LOD boundary map that is prepared in advance and includes the boundary surface of each LOD as illustrated in FIG. 12, that is, depending on which area the object is located in in these boundary maps.

<Reproduction Device>

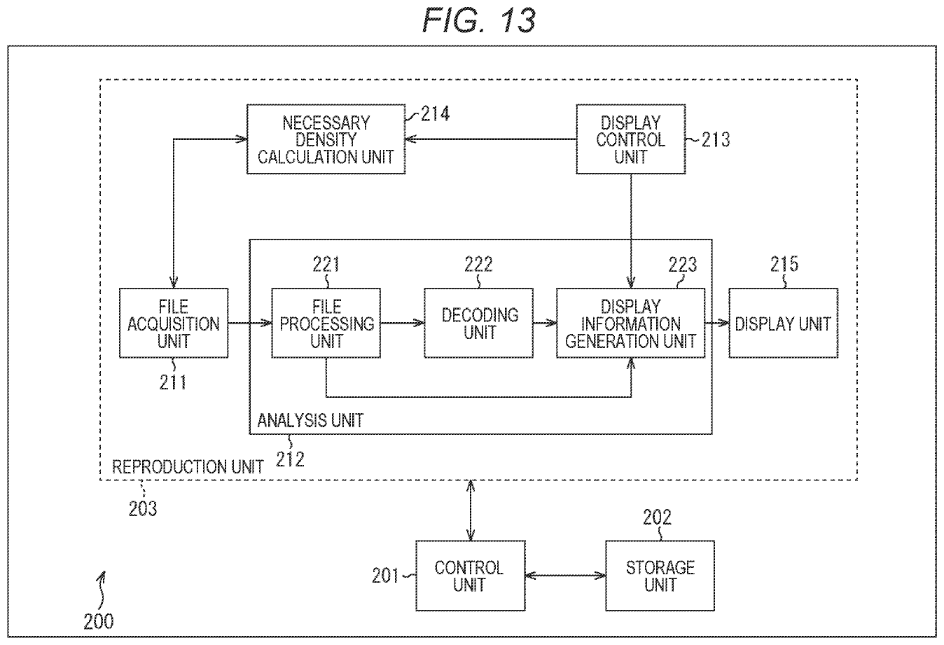

FIG. 13 is a block diagram illustrating an example of a configuration of a reproduction device that is an embodiment of an image processing apparatus to which the present technology is applied. A reproduction device 200 illustrated in FIG. 13 is a device that reproduces, that is, renders and displays 3D data such as a point cloud. More specifically, the reproduction device 200 acquires, decodes, renders, and displays coded data of point cloud data distributed from a server or the like. At that time, the reproduction device 200 selects and acquires a desired LoD from among a plurality of LoDs of point cloud data prepared in the server.

At that time, the reproduction device 200 selects the LoD by adopting the method described above. That is, the reproduction device 200 calculates, on the basis of the display size of a point cloud object depending on the relative position of the point cloud object based on the position of a viewpoint, the necessary point density that is the density of points necessary for displaying the point cloud object, and selects and acquires the content file of LoD in which the density of points of the point cloud object is equal to or higher than the calculated necessary point density.

Note that, main components such as processing units and data flows are illustrated in FIG. 13, and those illustrated in FIG. 13 are not necessarily everything. That is, in the reproduction device 200, there may be a processing unit not illustrated as a block in FIG. 13, or there may be a process or a data flow not illustrated as an arrow or the like in FIG. 13.

As illustrated in FIG. 13, the reproduction device 200 includes a control unit 201, a storage unit 202, and a reproduction unit 203.

The control unit 201 performs processing related to control of the reproduction unit 203. At that time, the control unit 201 can store information necessary for the control, such as programs and data, in the storage unit 202, and read information stored in the storage unit 202.

The reproduction unit 203 performs processing related to reproduction of point cloud data. As illustrated in FIG. 13, the reproduction unit 203 includes a file acquisition unit 211, an analysis unit 212, a display control unit 213, a necessary density calculation unit 214, and a display unit 215.

The file acquisition unit 211 performs processing related to file acquisition. For example, the file acquisition unit 211 selects a LoD content file on the basis of the necessary point density (the point density (the point interval) necessary for suppressing the degradation of the subjective image quality) calculated by the necessary density calculation unit 214, and acquires the selected LoD content file.

The analysis unit 212 performs processing related to the analysis of the point cloud data (the LoD content file) acquired by the file acquisition unit 211. For example, the analysis unit 212 decodes and renders the coded data of the point cloud data, thereby generating display information (a display image or the like).

The display control unit 213 performs processing related to display control. For example, the display control unit 213 controls the generation of display information by a display information generation unit 223 to be described later. Furthermore, the display control unit 213 provides information (viewing device information) related to the viewing device (that is, the display unit 215) that displays a display image to the necessary density calculation unit 214.

The necessary density calculation unit 214 performs processing related to calculation of a point density (a point interval) necessary for suppressing the degradation of subjective image quality. For example, the necessary density calculation unit 214 calculates a necessary point density on the basis of the information related to a viewing device supplied from the display control unit 213, the information related to an object supplied from the file acquisition unit 211, and the like, and supplies the calculated necessary point density to the file acquisition unit 211.

The display unit 215 includes a display device, and performs processing related to display. For example, the display unit 215 displays display information generated by the display information generation unit 223 to be described later on the display device.

As illustrated in FIG. 13, the analysis unit 212 includes a file processing unit 221, a decoding unit 222, and the display information generation unit 223.

The file processing unit 221 performs processing related to a LoD content file. For example, the file processing unit 221 acquires coded data of point cloud data of an object to be processed from the LoD content file supplied from the file acquisition unit 211, and supplies the coded data to the decoding unit 222. Furthermore, the file processing unit 221 supplies the information related to the object to the display information generation unit 223.

The decoding unit 222 performs processing related to decoding. For example, the decoding unit 222 decodes the coded data supplied from the file processing unit 221, generates point cloud data of the object to be processed, and supplies the point cloud data to the display information generation unit 223.

The display information generation unit 223 performs processing related to generation of display information such as a display image. For example, in accordance with the control of the display control unit 213, the display information generation unit 223 renders the point cloud data supplied from the decoding unit 222, generates display information, and supplies the display information to the display unit 215.

<Flow of Reproduction Process>

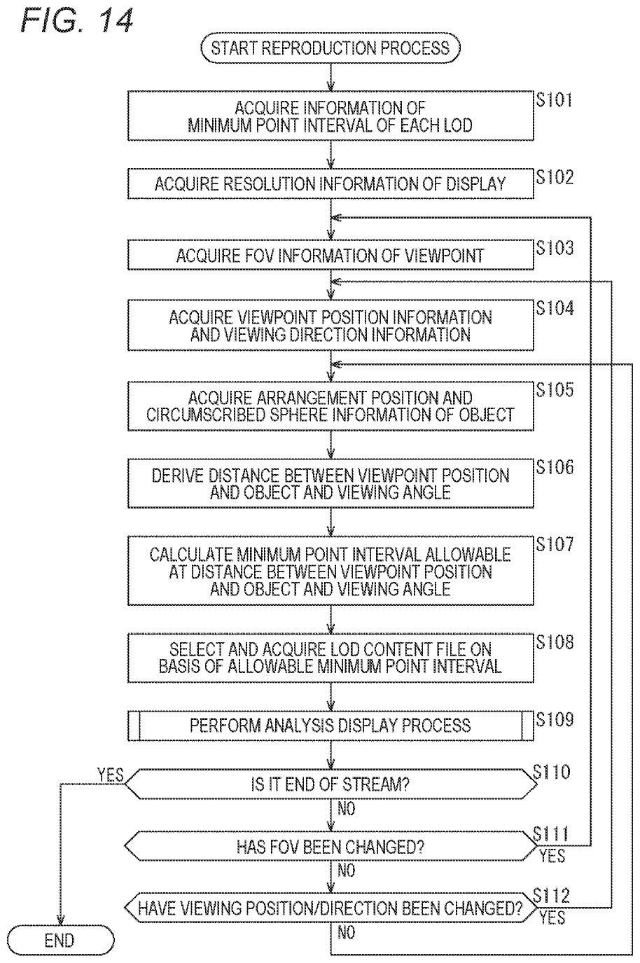

An example of a flow of the reproduction process performed by the reproduction device 200 will be described with reference to a flowchart of FIG. 14.

When the reproduction process is started, the file acquisition unit 211 acquires information of the minimum point interval of each LoD in step S101.

In step S102, the necessary density calculation unit 214 acquires, as viewing device information that is information related to a viewing device, resolution information indicating the resolution of a display from the display control unit 213.

In step S103, the necessary density calculation unit 214 acquires, as information related to the viewpoint of the viewing device information, FOV information indicating the FOV of a viewpoint from the display control unit 213.

In step S104, the necessary density calculation unit 214 acquires, as information related to the viewpoint, viewpoint position information indicating the position of the viewpoint and viewing direction information indicating a viewpoint orientation from the display control unit 213.

In step S105, the necessary density calculation unit 214 acquires, as object information that is information related to a point cloud object to be processed, the position and circumscribed sphere information of the object to be processed from the file acquisition unit 211. That is, the object information includes information related to the position and size of the point cloud object.

In step S106, the necessary density calculation unit 214 derives the distance between the viewpoint position and the object and a viewing angle on the basis of the viewpoint position and the object position.

In step S107, the necessary density calculation unit 214 calculates a point interval allowable at the distance between the viewpoint position and the object and the viewing angle, that is, a point interval (a necessary point density) necessary for suppressing the degradation of the subjective image quality.

In step S108, the file acquisition unit 211 selects and acquires a LoD content file on the basis of the allowable point interval (the necessary point density) calculated by the necessary density calculation unit 214 in step S107. For example, the file acquisition unit 211 selects a LoD content file (LoD content files with a point density that is denser than the necessary point density and closest to the necessary point density) with a point interval narrower than the allowable point interval and with the largest point interval among the LoD content files.

In step S109, the analysis unit 212 performs an analysis display process on the LoD content file acquired in step S108, and generates display information of the object to be processed.

In step S110, the file processing unit 221 determines whether or not it is the end of a stream. If it is determined that it is the end, the reproduction process ends. On the other hand, if it is determined that it is not the end, the process proceeds to step S111.

In step S111, the display control unit 213 determines whether or not the field of view (FOV) has been changed. If it is determined that the FOV has been changed, the processing returns to step S103. If it is determined that the FOV has not been changed, the processing proceeds to step S112.

In step S112, the display control unit 213 determines whether or not the viewpoint position and the direction have been changed. If it is determined that the viewpoint position and the direction have been changed, the process returns to step S104. On the other hand, if it is determined that the viewpoint position and the direction have not been changed, the process returns to step S105.

<Flow of Analysis Display Process>

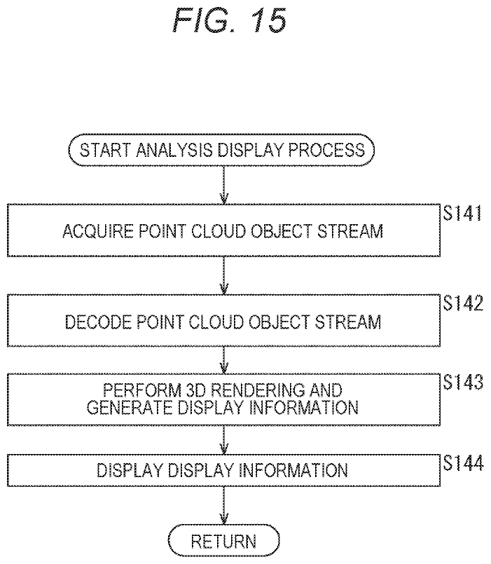

Next, an example of a flow of the analysis display process performed in step S109 of FIG. 14 will be described with reference to a flowchart of FIG. 15.

When the analysis display process is started, in step S141, the file processing unit 221 acquires a point cloud object stream that is the coded data of the point cloud data of the object to be processed from the LoD content file acquired in step S108 of FIG. 14.

In step S142, the decoding unit 222 decodes the point cloud object stream, and generates point cloud data of the object to be processed.

In step S143, the display information generation unit 223 performs 3D rendering of the point cloud data to generate display information.

In step S144, the display unit 215 displays the display information on the display.

When the process of step S144 ends, the analysis display process ends, and the process returns to FIG. 14.

As described above, by performing each process, the reproduction device 200 can select LoD so as not to degrade the subjective image quality depending on the display size of the point cloud object. Therefore, it is possible to suppress the degradation of the subjective image quality while suppressing an increase in load.

### 2. SECOND EMBODIMENT

<Application of Interpolation Process>

Further, interpolation with insufficient definition may be performed. That is, on the basis of the display size of a point cloud object depending on the relative position of the point cloud object based on a viewpoint position, the necessary point density that is the density of points necessary for displaying the point cloud object may be calculated, the content file of LoD may be selected on the basis of the distance from the viewpoint to the point cloud object, and the density of points of the point cloud object in the content file of the selected LoD may be corrected so as to be equal to or larger than the calculated necessary point density.

For example, the image processing apparatus may include a necessary density calculation unit that calculates, on the basis of the display size of the point cloud object depending on the relative position of the point cloud object based on the viewpoint position, the necessary point density that is the density of points necessary for displaying the point cloud object, a selection unit that selects the content file of the LoD on the basis of the distance from the viewpoint to the point cloud object, and a correction unit that corrects the density of points of the point cloud object in the content file of the LoD selected by the selection unit so as to be equal to or larger than the necessary point density calculated by the necessary density calculation unit.

As a result, the point density (the point interval) can be corrected depending on the display size of the point cloud object so that the subjective image quality is not degraded. Therefore, it is possible to suppress the degradation of the subjective image quality while suppressing an increase in load.

<Cooperation Between LOD Switching with Reduced Definition and Interpolation Process>

In the case of this method, LOD switching is performed in such a manner that the definition becomes insufficient, for example, LOD switching is performed only with the conventional LOD distance, and comparison between a point interval that is necessary and sufficient and a point interval of the LOD model currently reproduced is used for determining whether the point interpolation process such as an upsampling process is performed. As a result, the amount of information to be acquired can be reduced as compared with the method described in the first embodiment, and if this correction process can be appropriately performed, the degradation of image quality due to insufficient definition can also be suppressed.

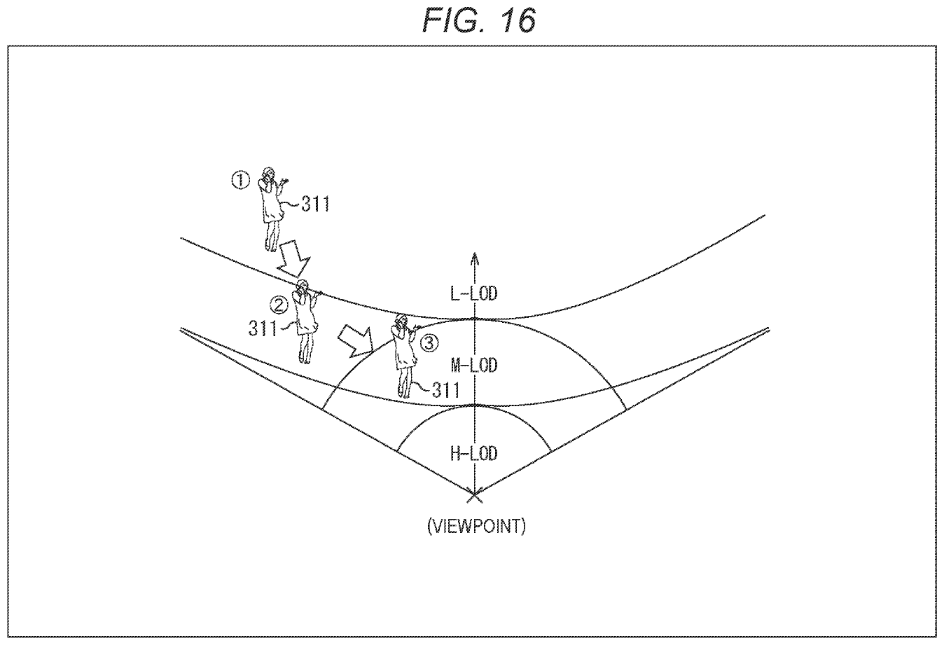

For example, under a situation where the substantial LOD boundary is like the boundary map in B of FIG. 12, the LOD switching is performed on the line of the boundary map in A of FIG. 12. That is, the LOD is switched depending on a distance. Here, FIG. 16 illustrates a boundary map in which the boundary line in the boundary map in A of FIG. 12 and the boundary line in the boundary map in B of FIG. 12 are superimposed on each other.

Here, as illustrated in FIG. 16, it is assumed that one object 311 moves in the order of 1→2→3 in the drawing (each number is surrounded by a circle in the drawing).

1: Low-LOD is acquired/reproduced, and correction related to a point (a point density) such as upsampling is not performed.

2: Low-LOD is acquired/reproduced, and correction related to a point (a point density) such as upsampling is performed.

3: Mid-LOD is acquired/reproduced, and correction related to a point (a point density) such as upsampling is not performed.

As described above, it is possible to determine whether or not the definition is insufficient from “point density (point interval) necessary for suppressing degradation of subjective image quality” calculated as described in the first embodiment and the point density information of each LOD, and it is possible to perform the interpolation process such as the upsampling process at an appropriate timing.

<Grasping Situation of Insufficient Definition and Correction>

As described above in the first embodiment, there are two “point intervals necessary for suppressing degradation of subjective image quality” in the horizontal direction and the vertical direction. “Point interval for suppressing degradation of subjective image quality” in the horizontal direction can be calculated by using the stretching magnification in the horizontal direction of equation (4), and “point interval for suppressing degradation of subjective image quality” in the vertical direction can be calculated by using the stretching magnification in the vertical direction of equation (5).

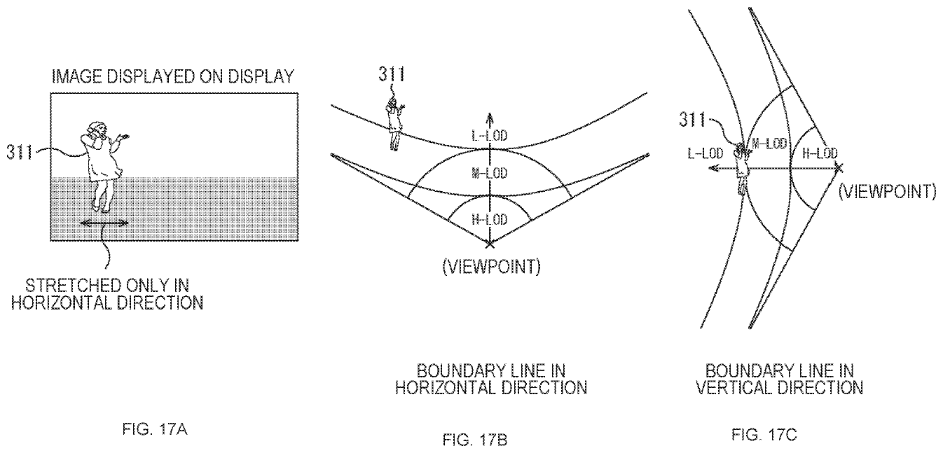

FIG. 17 is a diagram illustrating an example of a case where stretching is performed only in the horizontal direction. A of FIG. 17 illustrates an example of a display screen of a display in that case, B of FIG. 17 illustrates an LOD boundary line in the horizontal direction and the position of the object 311 in that case, and C of FIG. 17 illustrates an LOD boundary line in the vertical direction and the position of the object 311 in that case.

In this case, as illustrated in B of FIG. 17, it can be seen that there is a certain viewing angle in the horizontal direction, and stretching distortion in the horizontal direction occurs. Furthermore, as illustrated in C of FIG. 17, in the vertical direction, the object is positioned at the center of the projection plane, and the viewing angle in the vertical direction is 0 degrees. Therefore, stretching distortion in the vertical direction does not occur.

In the boundary map in B of FIG. 17, the position of the object 311 in the horizontal direction is located in an area where Low-LOD is acquired, but in practice, is a position where Mid-LOD is to be acquired. Therefore, the definition in the horizontal direction is insufficient. In such a case, the point density (the point interval) is corrected.

In the boundary map in C of FIG. 17, the position of the object 311 in the vertical direction is a position where the definition of Low-LOD suffices. Therefore, insufficient definition in the horizontal direction does not occur. In such a case, the point density (the point interval) is not corrected.

That is, in this case, the definition is insufficient only in the horizontal direction. Therefore, the point density (the point interval) is corrected only in the horizontal direction.

As a method of correcting the point density (the point interval), for example, point upsampling may be adopted.

In this case, it is assumed that the Low-LOD point interval, the point interval necessary for suppressing the degradation of the subjective image quality in the horizontal direction, and the point interval necessary for suppressing the degradation of the subjective image quality in the vertical direction have the following values.

Low-LOD point interval: 0.003 (m)

Point interval necessary for suppressing degradation of subjective image quality in vertical direction: 0.003 (m)

Point interval necessary for suppressing degradation of subjective image quality in horizontal direction: 0.001 (m)

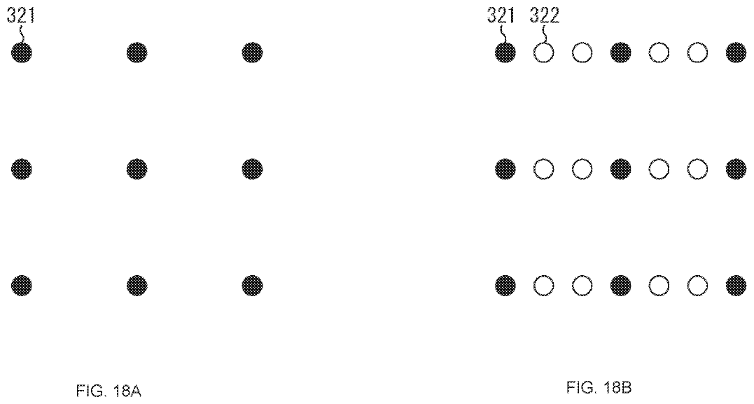

In such a case, for example, as illustrated in B of FIG. 18, a group of points 322 indicated by white circles is added to a group of original model data points 321 indicated by black circles in A of FIG. 18, and the points are upsampled three times only in the horizontal direction. That is, the interval is set to 0.001 (m) only in the horizontal direction by upsampling.

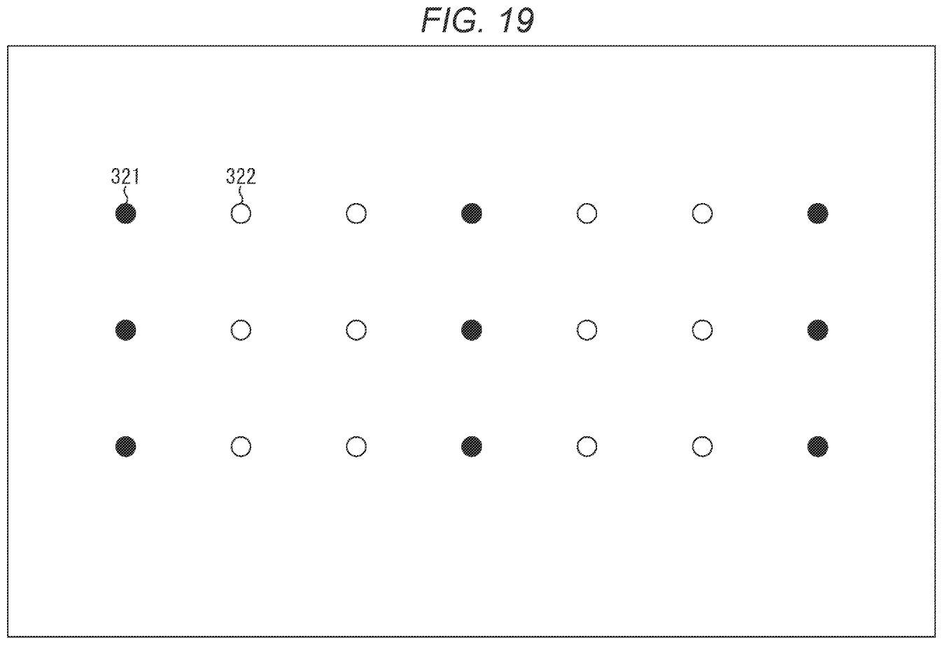

As a result, the object is stretched in the horizontal direction as in the example of FIG. 17, and as illustrated in FIG. 19, the point interval becomes 0.003 (m) in both the horizontal direction and the vertical direction. That is, in both the horizontal direction and the vertical direction, the point interval (the point density) necessary for suppressing the degradation of the subjective image quality is obtained. Therefore, it is possible to suppress the degradation of the subjective image quality while suppressing an increase in load.

As described above in the first embodiment, by correcting the point interval (the point density) such as upsampling on the basis of “point interval necessary for suppressing degradation of subjective image quality”, efficient interpolation can be performed without waste, that is, only the insufficient portion can be interpolated.

Note that any method of correcting the point interval (the point density) can be used, and is not limited to upsampling (a point interpolation process). For example, as the correction process, the point display size (the number of pixels) may be increased (increased).

For example, the point interval (the point density) may be corrected by changing (increasing) the display size of one point normally displayed as one pixel, to, for example, 2×2 pixels, 3×3 pixels, or 4×4 pixels.

At that time, as in the example described above, the point display size may be the same in the horizontal direction and the vertical direction, or the display size in the horizontal direction and the display size in the vertical direction may be controlled independently of each other in accordance with the stretching rates in the horizontal direction and the vertical direction. For example, in the examples of FIGS. 17 to 19, the point display size (vertical direction×horizontal direction) may be 1×3 pixels. As a result, it is possible to more appropriately correct the situation of insufficient definition.

As described above, by referring to the “point interval necessary for suppressing degradation of subjective image quality”, it is possible to more accurately grasp the situation of insufficient definition of a point cloud object and to perform a more appropriate correction process. Therefore, “cooperation between LOD switching with reduced definition and interpolation process” as illustrated in FIG. 16 can be achieved.

<Reproduction Device>

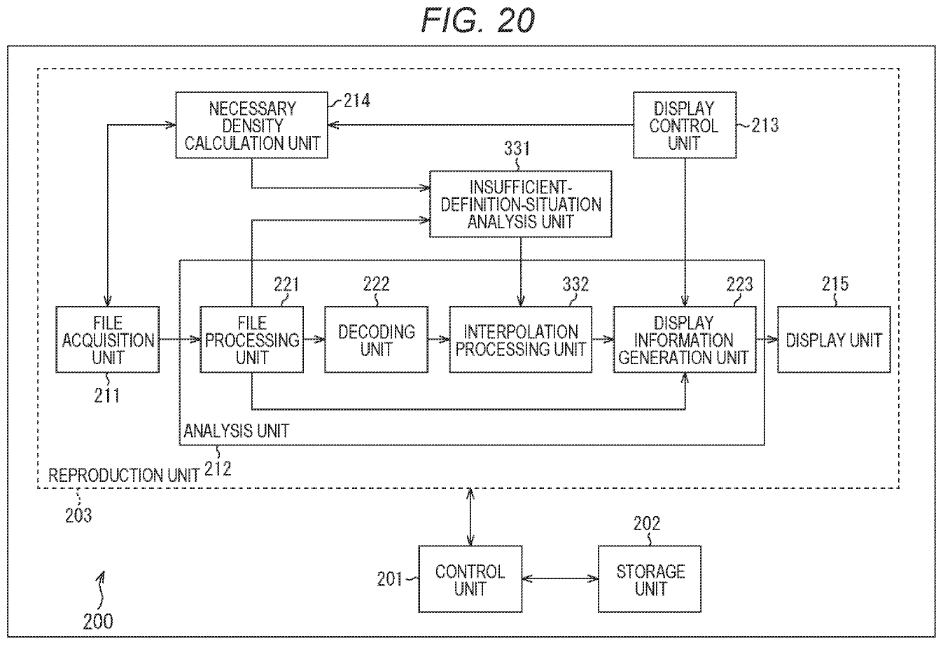

FIG. 20 illustrates a main configuration example of the reproduction device 200 in a case where such processing is performed. As illustrated in FIG. 20, the reproduction unit 203 of the reproduction device 200 in this case includes an insufficient-definition-situation analysis unit 331 in addition to the configuration of FIG. 13. Furthermore, the analysis unit 212 includes an interpolation processing unit 332 in addition to the configuration of FIG. 13.

The insufficient-definition-situation analysis unit 331 performs processing related to the analysis of an insufficient definition situation. For example, the insufficient-definition-situation analysis unit 331 obtains the insufficient definition situation (in each of the horizontal direction and the vertical direction) as described above on the basis of the information (in each of the horizontal direction and the vertical direction) related to the point interval (the point density) necessary for suppressing the degradation of the subjective image quality supplied from the necessary density calculation unit 214 and the point interval (the point density) of the current LoD model data supplied from the file processing unit 221. The insufficient-definition-situation analysis unit 331 supplies information indicating the obtained insufficient definition situation to the interpolation processing unit 332.

The interpolation processing unit 332 performs processing related to a point interpolation. For example, the interpolation processing unit 332 acquires point cloud data of an object to be processed supplied from the decoding unit 222, performs the point interpolation process (for example, upsampling) on the point cloud data on the basis of the information indicating the insufficient definition situation supplied from the insufficient-definition-situation analysis unit 331, and supplies the processing result (the point cloud data after the interpolation process) to the display information generation unit 223.

The display information generation unit 223 generates display information using the point cloud data interpolated by the interpolation processing unit 332.

As a result, it is possible to achieve “cooperation between LOD switching with reduced definition and interpolation process”.

<Flow of Reproduction Process>

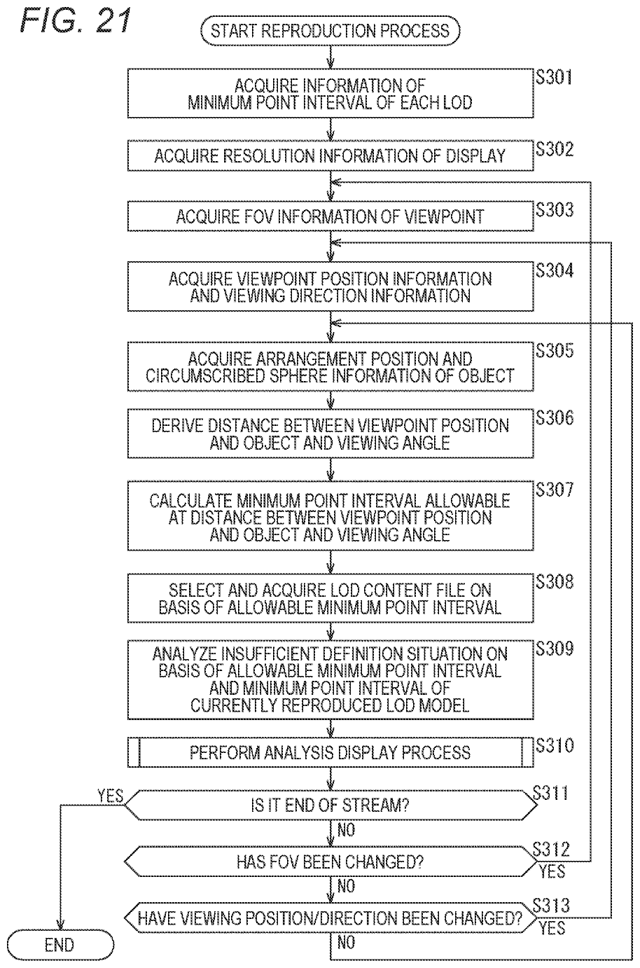

An example of a flow of the reproduction process performed by the reproduction device 200 in this case will be described with reference to a flowchart of FIG. 21.

When the reproduction process is started, each of the processes of steps S301 to S307 is performed similarly to each of the processes of steps S101 to S107 (FIG. 14). Note that the process in step S301 is performed by the insufficient-definition-situation analysis unit 331.

In step S308, the file acquisition unit 211 selects and acquires a LoD content file on the basis of the distance between a viewpoint position and a position of an object to be processed. For example, the file acquisition unit 211 selects the LoD content file on the basis of the boundary map illustrated in A of FIG. 12.

In step S309, the insufficient-definition-situation analysis unit 331 analyzes the insufficient definition situation on the basis of an allowable point interval (that is, a point interval (a point density) necessary for suppressing the degradation of the subjective image quality) and the point interval of the LOD model being currently reproduced. The insufficient-definition-situation analysis unit 331 analyzes the insufficient definition situation in each of the horizontal direction and the vertical direction.

Each of the processes of steps S310 to S313 is performed similarly to each of the processes of steps S109 to S112 (FIG. 14).

<Flow of Analysis Display Process>

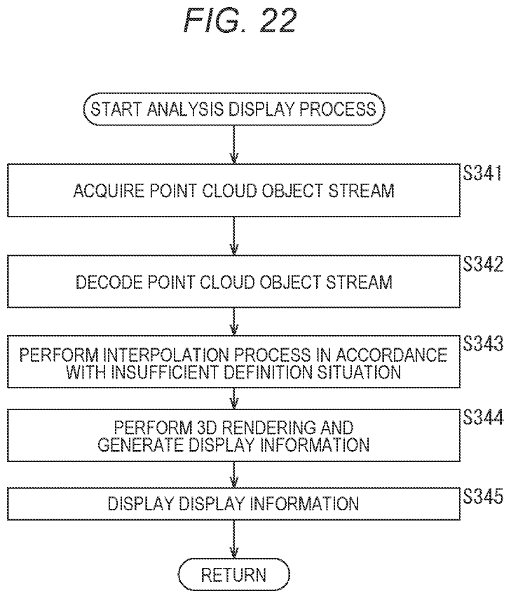

Next, an example of a flow of the analysis display process performed in step S310 of FIG. 21 will be described with reference to a flowchart of FIG. 22.

In this case, when the analysis display process is started, each of the processes of steps S341 and S342 is performed similarly to each of the processes of steps S141 and S142 (FIG. 15).

In step S343, the interpolation processing unit 332 performs a point interpolation process such as upsampling, in accordance with the insufficient definition situation analyzed by the insufficient-definition-situation analysis unit 331 in step S309 (FIG. 21). The interpolation processing unit 332 performs this interpolation process in each of the horizontal direction and the vertical direction.

By using the point cloud data after the interpolation process, each of the processes of steps S344 and S345 is performed similarly to each of the processes of steps S143 and S144 (FIG. 15). When the process of step S345 ends, the analysis display process ends, and the process returns to FIG. 21.

As described above, by performing the individual processes, the reproduction device 200 can achieve “cooperation between LOD switching with reduced definition and interpolation process”. Therefore, it is possible to suppress the degradation of the subjective image quality while suppressing an increase in load.

### 3. APPENDIX

<Computer>

The series of processing described above can be performed by hardware or software. In a case where the series of processing is performed by software, a program constituting the software is installed in a computer. Here, the computer includes a computer incorporated in dedicated hardware, a general-purpose personal computer capable of performing various functions by installing various programs, and the like, for example.

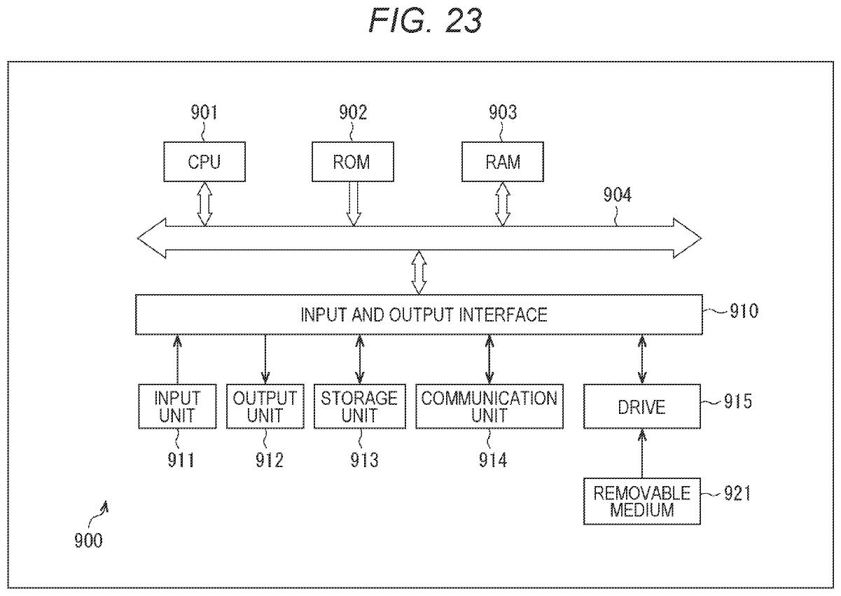

FIG. 23 is a block diagram illustrating a configuration example of hardware of a computer that performs the series of processing described above with a program.

In a computer 900 illustrated in FIG. 23, a central processing unit (CPU) 901, a read only memory (ROM) 902, and a random access memory (RAM) 903 are mutually connected via a bus 904.

An input and output interface 910 is also connected to the bus 904. An input unit 911, an output unit 912, a storage unit 913, a communication unit 914, and a drive 915 are connected to the input and output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a nonvolatile memory, and the like. The communication unit 914 includes, for example, a network interface. The drive 915 drives a removable medium 921 such as a magnetic disk, an optical disk, a magneto-optical disk, or a semiconductor memory.

In the computer configured as described above, for example, the CPU 901 loads a program stored in the storage unit 913 into the RAM 903 via the input and output interface 910 and the bus 904 and executes the program, so that the series of processing described above is performed. The RAM 903 also appropriately stores data and the like necessary for the CPU 901 to perform various types of processing.

The program executed by the computer can be applied by being recorded in the removable medium 921 functioning as a package medium or the like, for example. In this case, the program can be installed in the storage unit 913 via the input and output interface 910 by attaching the removable medium 921 to the drive 915.

Furthermore, this program can also be provided via a wired or wireless transmission medium such as a local area network, the Internet, or digital satellite broadcasting. In this case, the program can be received by the communication unit 914 and installed in the storage unit 913.

In addition, this program can be installed in the ROM 902 or the storage unit 913 in advance.

<Object to which Present Technology is Applied>

Although the case where the present technology is applied to reproduction of point cloud data has been described above, 3D data to which the present technology can be applied is not limited to this example. That is, as long as there is no contradiction with the present technology described above, any specification of various data such as 3D data and metadata may be used. In addition, as long as there is no contradiction with the present technology, some processes and specifications described above may be omitted.

Furthermore, the reproduction device 200 and the like have been described above as an application example of the present technology, but the present technology can be applied to any configuration.

For example, the present technology can be applied to various electronic devices such as a transmitter and a receiver (for example, a television receiver and a mobile phone) in satellite broadcasting, cable broadcasting such as cable TV, distribution on the Internet, and distribution to a terminal by cellular communication, or a device (for example, a hard disk recorder and a camera) that records an image on a medium such as an optical disk, a magnetic disk, or a flash memory, or reproduces an image from the storage medium.

Furthermore, for example, the present technology can also be implemented as a partial configuration of a device, such as a processor (for example, a video processor) as a system large scale integration (LSI) or the like, a module (for example, a video module) using a plurality of processors or the like, a unit (for example, a video unit) using a plurality of modules or the like, or a set (for example, a video set) obtained by further adding other functions to a unit.

Further, for example, the present technology can also be applied to a network system including a plurality of devices. For example, the present technology may be implemented as cloud computing in which one function is shared and processed in cooperation by a plurality of devices via a network. For example, the present technology may be implemented in a cloud service that provides a service related to an image (a moving image) to any terminal such as a computer, an audio visual (AV) device, a portable information processing terminal, or an Internet of Things (IoT) device.

Note that, in the present specification, a system means a set of a plurality of components (devices, modules (parts), and the like), and it does not manner whether or not all the components are in the same housing. Accordingly, the system includes a plurality of devices housed in separate housings and connected via a network and one device in which a plurality of modules is housed in one housing.

<Field and Application to which Present Technology is Applicable>

The system, the device, the processing unit, and the like to which the present technology is applied can be used in any field such as transportation, medical care, crime prevention, agriculture, livestock industry, mining industry, beauty care, factories, home appliances, weather, and nature monitoring. In addition, the application thereof is also freely selected.

<Others>

The embodiments of the present technology are not limited to the embodiments described above, and various changes can be made without departing from the gist of the present technology.

For example, the configuration described as one device (or one processing unit) may be divided and configured as a plurality of devices (or a plurality of processing units). Conversely, the configurations described above as plural devices (or plural processing units) may be collectively configured as one device (or one processing unit). Furthermore, a configuration other than the configuration described above may be added to the configuration of each device (or each processing unit). Further, as long as the configuration and operation of the entire system are substantially the same, a part of the configuration of a certain device (or a certain processing unit) may be included in the configuration of another device (or another processing unit).

Furthermore, for example, the program may be executed in any device. In that case, it is only required that the device has a necessary function (a necessary functional block or the like) and can obtain necessary information.

Furthermore, for example, each step of one flowchart may be performed by one device, or may be shared and performed by a plurality of devices. Moreover, in a case where a plurality of processes is included in one step, the plurality of processes may be performed by one device or may be shared and performed by a plurality of devices. In other words, a plurality of processes included in one step can also be performed as processes of a plurality of steps. Conversely, the processes described as a plurality of steps can be collectively performed as one step.

Furthermore, for example, the program executed by the computer may be a program in which the processes in steps describing the program are performed in time series in the order described in the present specification, or may be a program in which the processes are performed in parallel or at a necessary timing such as when a call is made. That is, as long as there is no contradiction, the processes in the individual steps may be performed in an order different from the order described above. Moreover, the processes in steps describing this program may be performed in parallel with the processing of another program, or may be performed in combination with the processing of another program.

Furthermore, for example, a plurality of techniques related to the present technology can be implemented independently as a single technique as long as there is no contradiction. Of course, any plural present technologies can be implemented in combination. For example, some or all of the present technology described in any of the embodiments can be implemented in combination with some or all of the present technology described in other embodiments. Moreover, some or all of any present technology can be implemented in combination with other technologies not described above.

Note that the present technology can also have the following configurations.

(1) An image processing apparatus including:

a necessary density calculation unit that calculates, on the basis of a display size of a point cloud object depending on a relative position of the point cloud object based on a position of a viewpoint, a necessary point density that is a density of points necessary for displaying the point cloud object; and

a selection unit that selects a content file of LoD in which a density of points of the point cloud object is equal to or higher than the necessary point density calculated by the necessary density calculation unit.

(2) The image processing apparatus according to (1), in which

the necessary density calculation unit calculates, as the display size, a stretching magnification from a display size of the point cloud object in an orientation of the viewpoint depending on a relative angle of the point cloud object based on the orientation of the viewpoint, and calculates the necessary point density by using the stretching magnification.

(3) The image processing apparatus according to (2), in which

the necessary density calculation unit calculates the necessary point density by using a larger one of the stretching magnification in a horizontal direction and the stretching magnification in a vertical direction.

(4) The image processing apparatus according to (3), in which

the necessary density calculation unit calculates the stretching magnifications in a horizontal direction and in a vertical direction on the basis of object information that is information related to the point cloud object and viewing device information that is information related to a viewing device that displays the point cloud object.

(5) The image processing apparatus according to (4), in which

the object information includes information related to a position of the point cloud object and information related to a size of the point cloud object.

(6) The image processing apparatus according to (5), in which

information related to the size of the point cloud object includes information related to a circumscribed sphere circumscribing the point cloud object.

(7) The image processing apparatus according to any one of (4) to (6), in which

the viewing device information includes information related to a display resolution of the viewing device and information related to the viewpoint.

(8) The image processing apparatus according to (7), in which

information related to the viewpoint includes information related to a position of the viewpoint, information related to an orientation of the viewpoint, and information related to a viewing angle of the viewpoint.

(9) The image processing apparatus according to any one of (1) to (8), in which

the selection unit selects a content file of LoD in which a density of points of the point cloud object is equal to or higher than the necessary point density and minimum.

(10) An image processing method including:

calculating, on the basis of a display size of a point cloud object depending on a relative position of the point cloud object based on a position of a viewpoint, a necessary point density that is a density of points necessary for displaying the point cloud object; and

selecting a content file of LoD in which a density of points of the point cloud object is equal to or higher than the necessary point density calculated.

(11) An image processing apparatus including:

a necessary density calculation unit that calculates, on the basis of a display size of a point cloud object depending on a relative position of the point cloud object based on a position of a viewpoint, a necessary point density that is a density of points necessary for displaying the point cloud object;

a selection unit that selects a content file of LoD on the basis of a distance from the viewpoint to the point cloud object; and

a correction unit that corrects a density of points of the point cloud object in the content file of the LoD selected by the selection unit so as to be equal to or higher than the necessary point density calculated by the necessary density calculation unit.

(12) The image processing apparatus according to (11), in which

the correction unit corrects a density of points of the point cloud object in each of a horizontal direction and a vertical direction.

(13) The image processing apparatus according to (11) or (12), in which

the correction unit corrects a density of points of the point cloud object by interpolating points.

(14) The image processing apparatus according to any one of (11) to (13), in which

the correction unit corrects a density of points of the point cloud object by increasing a point size.

(15) An image processing method including:

calculating, on the basis of a display size of a point cloud object depending on a relative position of the point cloud object based on a position of a viewpoint, a necessary point density that is a density of points necessary for displaying the point cloud object;

selecting a content file of LoD on the basis of a distance from the viewpoint to the point cloud object; and

correcting a density of points of the point cloud object in the content file of the LoD selected so as to be equal to or larger than the necessary point density calculated.

### REFERENCE SIGNS LIST

200 Reproduction device
201 Control unit
202 Storage unit
203 Reproduction unit
211 File acquisition unit
212 Analysis unit
213 Display control unit
214 Necessary density calculation unit
215 Display unit
221 File processing unit
222 Decoding unit
223 Display information generation unit
331 Insufficient-definition-situation analysis unit
332 Interpolation processing unit

1. An image processing apparatus comprising:
a necessary density calculation unit that calculates, on a basis of a display size of a point cloud object depending on a relative position of the point cloud object based on a position of a viewpoint, a necessary point density that is a density of points necessary for displaying the point cloud object; and
a selection unit that selects a content file of LoD in which a density of points of the point cloud object is equal to or higher than the necessary point density calculated by the necessary density calculation unit.

2. The image processing apparatus according to claim 1, wherein
the necessary density calculation unit calculates, as the display size, a stretching magnification from a display size of the point cloud object in an orientation of the viewpoint depending on a relative angle of the point cloud object based on the orientation of the viewpoint, and calculates the necessary point density by using the stretching magnification.

3. The image processing apparatus according to claim 2, wherein
the necessary density calculation unit calculates the necessary point density by using a larger one of the stretching magnification in a horizontal direction and the stretching magnification in a vertical direction.

4. The image processing apparatus according to claim 3, wherein
the necessary density calculation unit calculates the stretching magnifications in a horizontal direction and in a vertical direction on a basis of object information that is information related to the point cloud object and viewing device information that is information related to a viewing device that displays the point cloud object.

5. The image processing apparatus according to claim 4, wherein
the object information includes information related to a position of the point cloud object and information related to a size of the point cloud object.

6. The image processing apparatus according to claim 5, wherein
information related to the size of the point cloud object includes information related to a circumscribed sphere circumscribing the point cloud object.

7. The image processing apparatus according to claim 4, wherein
the viewing device information includes information related to a display resolution of the viewing device and information related to the viewpoint.

8. The image processing apparatus according to claim 7, wherein
information related to the viewpoint includes information related to a position of the viewpoint, information related to an orientation of the viewpoint, and information related to a viewing angle of the viewpoint.

9. The image processing apparatus according to claim 1, wherein
the selection unit selects a content file of LoD in which a density of points of the point cloud object is equal to or higher than the necessary point density and minimum.

10. An image processing method comprising:
calculating, on a basis of a display size of a point cloud object depending on a relative position of the point cloud object based on a position of a viewpoint, a necessary point density that is a density of points necessary for displaying the point cloud object; and
selecting a content file of LoD in which a density of points of the point cloud object is equal to or higher than the necessary point density calculated.

11. An image processing apparatus comprising:
a necessary density calculation unit that calculates, on a basis of a display size of a point cloud object depending on a relative position of the point cloud object based on a position of a viewpoint, a necessary point density that is a density of points necessary for displaying the point cloud object;
a selection unit that selects a content file of LoD on a basis of a distance from the viewpoint to the point cloud object; and
a correction unit that corrects a density of points of the point cloud object in the content file of the LoD selected by the selection unit so as to be equal to or higher than the necessary point density calculated by the necessary density calculation unit.

12. The image processing apparatus according to claim 11, wherein
the correction unit corrects a density of points of the point cloud object in each of a horizontal direction and a vertical direction.

13. The image processing apparatus according to claim 11, wherein
the correction unit corrects a density of points of the point cloud object by interpolating points.

14. The image processing apparatus according to claim 11, wherein
the correction unit corrects a density of points of the point cloud object by increasing a point size.

15. An image processing method comprising:
calculating, on a basis of a display size of a point cloud object depending on a relative position of the point cloud object based on a position of a viewpoint, a necessary point density that is a density of points necessary for displaying the point cloud object;
selecting a content file of LoD on a basis of a distance from the viewpoint to the point cloud object; and
correcting a density of points of the point cloud object in the content file of the LoD selected so as to be equal to or larger than the necessary point density calculated.
